(19) United States
(12) Patent Application Publication
(10) Pub. No.: US 2012/0283996 A1
(43) Pub. Date: Nov. 8, 2012

(54) METHODS AND SYSTEMS FOR COMPUTER AIDED VEHICLE SEAT DESIGN

(75) Inventors: Joseph Benjamin Watson, Royal Oak, MI (US); David E. Watson, Trenton, MI (US)

(73) Assignee: FORD GLOBAL TECHNOLOGIES, LLC, Dearborn, MI (US)

(21) Appl. No.: 13/102,602

(22) Filed: May 6, 2011

(51) Int. Cl. G06F 17/50

(52) U.S. Cl. 703/1

(57) ABSTRACT

Various embodiments relate to methods and systems for computer-aided design. Modification size and/or position design data may be received at a computer for a first vehicle component having a functional and/or spatial relationship with a second vehicle component also having size and/or position design data. The size and/or position design data for the second vehicle component may be automatically updating at the computer based on the modification size and/or position design data for the first vehicle component. Based on the modification size and/or position design data and the updated size and/or position design data, a compliance status with one or more design standards defined for the vehicle component(s) for the first vehicle component or the second vehicle component may be determined.

### TECHNICAL FIELD

Various embodiments relate to designing a product, such as a vehicle, or a component of a product, such as a vehicle seat. In some embodiments, the design may be validated for compliance with regulatory and organizational standards.

### BACKGROUND

Computer Aided Design/Engineering (CAD) is the use of computer software to design objects. In the automotive industry, for example, CAD is often used to design vehicles and vehicle components such as vehicle seats.

Various examples exist in the art of such CAD tools. For example, U.S. Publication No. 2008/0015822 to Ziolek et al. discloses a method and system of computer assisted vehicle seat design (“Ziolek”). Ziolek discloses a method which may be applicable to any number of seating, including but not limited to vehicle seating commonly employed in automobiles, watercraft, aircraft, and others. The method optionally includes overlaying a shaped data object relative to an architectural drawing to facilitate assessing component comportment with desired structural boundaries.

### SUMMARY

One aspect may include a computer-implemented method for designing a vehicle assembly. In some embodiments, the vehicle assembly may be a vehicle seat.

The method may include receiving modification size and/or position design data at a computer for a first vehicle component. The first vehicle component may have a functional and/or spatial relationship with a second vehicle component which also has size and/or position design data. The size and/or position design data for the second vehicle component may be automatically updated based on the modification size and/or position design data for the first vehicle component. Further, a compliance status with one or more design standards defined for the vehicle component(s) for the first vehicle component or the second vehicle component may be determined at the computer based on the modification size and/or position design data and the updated size and/or position design data. The standards may pertain to government standards, standards defined by an automotive OEM, or both. In some embodiments, the compliance status may be presented at the computer.

Another aspect may include a system for designing a vehicle assembly. The system may include at least one data processor which may be configured to display data representing a design of one or more vehicle components of a vehicle part assembly. The one or more vehicle components may have associated size and/or position design values.

The at least one data processor may be further configured to receive a proposed modification to the one or more size and/or position design values of the one or more vehicle components. The one or more vehicle components may be associated with other vehicle components of the vehicle part assembly which may also have size and/or position design values. In some embodiments, the association may be a functional association, spatial association, and/or a zonal association.

In addition, the at least one data processor may be configured to update the size and/or position design values of the associated other vehicle components based on the proposed modification.

The at least one data processor may be configured to determine a compliance status of the vehicle component(s) with one or more standards defined for the vehicle component(s) based on the respective size and/or position design values. The at least one data processor may also be configured to present the compliance status.

Another aspect may include a system comprising at least one computer configured to receive modification design data for a vehicle component associated with at least one other vehicle component having design data. The design data may be size and/or position design data.

The at least one computer may be configured to correspondingly update the associated vehicle component design data based on modification design data. Further, the at least one computer may be configured to determine a compliance status for the vehicle component(s) with defined standards based on the modification and update

These and other aspects will be better understood in view of the attached drawings and the following detailed description.

### BRIEF DESCRIPTION OF THE DRAWINGS

The figures identified below are illustrative of some embodiments of the invention. The figures are not intended to be limiting of the invention recited in the appended claims. The embodiments, both as to their organization and manner of operation, together with further object and advantages thereof, may best be understood with reference to the following description, taken in connection with the accompanying drawings, in which:

FIG. 1 illustrates a system for computer aided design of vehicle components;

FIG. 2 illustrates a process for designing vehicle seats using the system of FIG. 1;

FIG. 3 illustrates a process associated with modifying a design of a vehicle component;

FIG. 4 illustrates a process for validating a design modification for compliance with predefined standards;

FIG. 5 illustrates a display of design templates for product design according to one embodiment; and

FIG. 6 illustrates a display validating that a designed component complies with one or more standards defined for a vehicle seat.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Additionally, the disclosure and arrangement of the figures is non-limiting. Accordingly, the disclosure and arrangement of the figures may be modified or re-arranged to best fit a particular implementation of the various embodiments of the invention.

The various embodiments of the methods and steps described herein may occur when a designer desires to modify the design of one or more aspects of a vehicle seat. If and when the design to a part or all of a seat is modified, that design may be used for the life cycle of the vehicle program or until a new design modification is made. In some embodiments, although not necessarily, the design modification may not be implemented until a final approval is provided from an engineering division (or other responsible business unit) of the OEM.

CAD tools may offer the ability to confirm that a proposed design modification complies with defined standards such as government defined standards. Using such tools, designers have the ability to know if a proposed design complies with one or more standards for a vehicle feature.

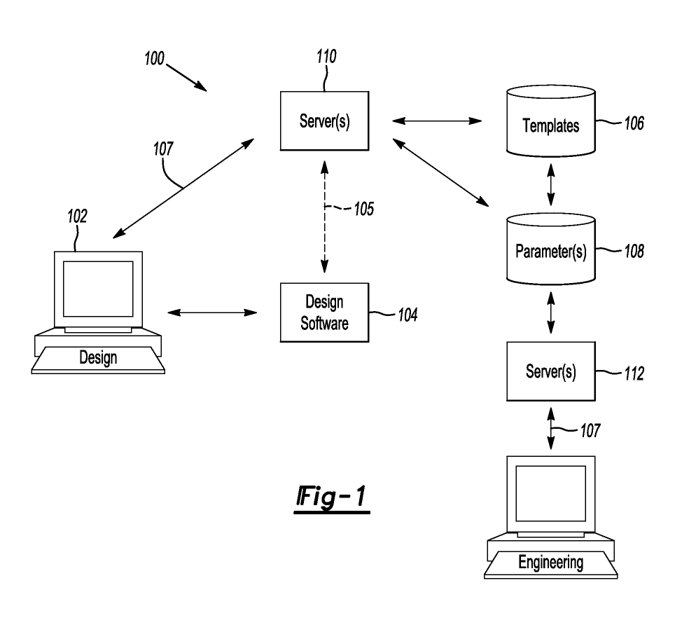

FIG. 1 illustrates a system for validating the computer aided design of a vehicle component such as a vehicle seat. While the various embodiments are described in the context of designing a vehicle component (and, more specifically, a vehicle seat), the various embodiments may be used in other environments as well.

From a user terminal 102, a designer may design a vehicle component using product design software 104. The software may be computer-aided design (CAD) software. Further, the software 104 may be installed and executing on the terminal 102 (stored in memory of the terminal 102) and/or executing 105 remotely, e.g., installed on a remote server 110 communicating with the terminal 102 over the Internet 107. While FIG. 1 illustrates a single terminal 102 for simplicity, the system 100 may comprise multiple terminals 102.

The design software 104 may provide a plurality of CAD-based design templates for use by a user (e.g., a designer) during design of the vehicle seat. The templates of CAD data may be stored in a template database 106. When the software 104 is executing on the terminal 102, the templates may be loaded for selection and execution. The templates may be selected using one or more computer input peripherals. The templates may be displayed at the terminal 102 as a textual or graphical list.

The vehicle seat design may be performed for each location of an occupant in a vehicle. The designer may design the vehicle seats for individual locations or multiple locations at once. Each location may have multiple associated design templates. For example, the template database 106 may include design templates for a driver and passengers. Further, the passenger templates may comprise templates for front seat passengers and back seat passengers. Each template in the database 106 may be assigned a unique identifier which may be used to identify the template when selecting a template to load. In one embodiment, the template identifier may include a combination of a program prefix (e.g., associated with the vehicle program, i.e., the vehicle line), a seat code and a model number.

In some embodiments, a wizard may be used to identify the design templates in planning a seat design for a particular vehicle program. Therefore, using the wizard, the template sets that are needed to support deliverables for the vehicle program may be identified. As there may be multiple vehicle platforms with multiple vehicle lines within the platform, multiple variations of seat designs for each line and, further, multiple occupant packaging positions planned for the vehicle, the wizard may assist in filtering through this complexity to identify the needed templates. As a non-limiting example, there may be 68 different seat codes which, based on the number of template sets, could result in hundreds of unique variations. In some embodiments, the wizard may identify the templates through pre-defined answers (e.g., yes or no) from the designer to design-related questions.

To load a design template, a search may be executed from the software 104 to retrieve the available templates (e.g., from database 106) using a text-based search query or selecting a graphical command button to display a menu of available template files for selection (e.g., and without limitation, a “browse” button commonly associated with GUI based file retrieval).

In some embodiments, when a search is executed of the parent files or child files, the results of the search may also include the associated child template files (e.g., if the parent file is search) or the associated parent template files (e.g., if the child file is searched). Further, when a child template file is searched, the additional child files in the template family may be retrieved, as well.

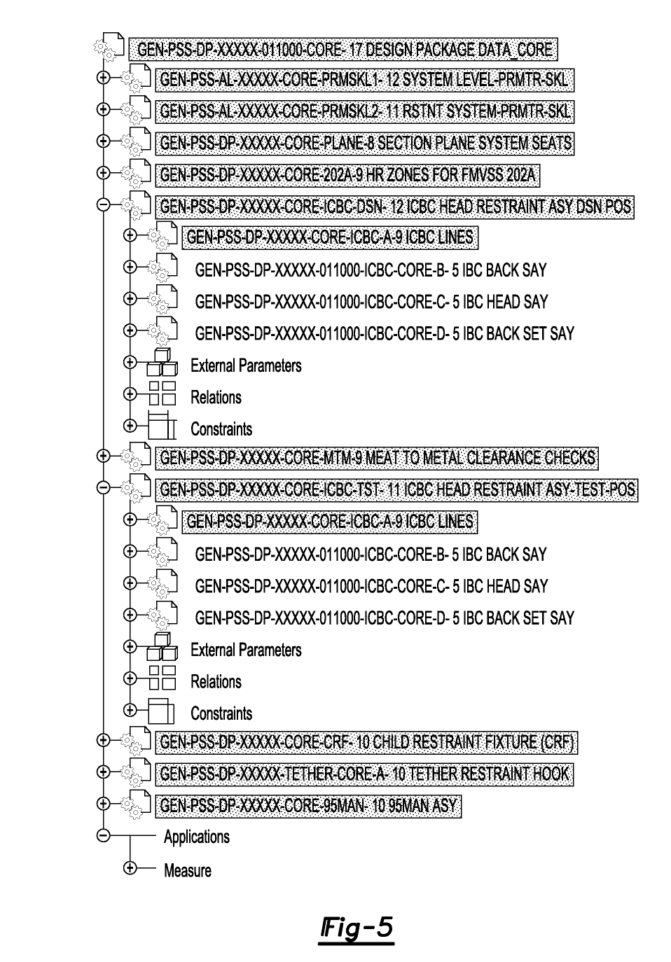

The template files may be arranged as a file tree (e.g., in a parent-child relationship). For example, a parent template file may be the design packages (e.g., templates) that are used for the vehicle program (identified by the unique identifier). Selecting the parent template file may cause the CAD illustration of the corresponding seat design (with all of the child template files) to be displayed at the terminal 102. The child templates associated with the parent templates may be the CAD illustration and parameters values for one or more parts associated with a vehicle occupant's seat. The child template files may be displayed by selecting an “expand” input on the display 102. Conversely, the child templates files may be hidden by selecting a “hide” or “minimize” input on the display 102. The “expand” and “hide” inputs may be graphical buttons position next to the template files having children which may be selected for showing or hiding the child files. Accordingly, there may be multiple child templates associated with each part for each parent. For example, and without limitation, a head restraint for a particular occupant location may have 12 associated child-template files. The content of the child template file may be displayed by selecting the corresponding file. A non-limiting example of this file tree is shown in FIG. 5.

Design templates may be created and saved to the templates database 106 using the seat design software 104. Creating templates may include modifying templates already saved to the templates database 106 (and saving the modified template as a new template) or creating an entirely new template.

Design parameters 108 for the vehicle seats (e.g., the size and/or position values for the vehicle seats) may alternatively or additionally be directly modified. The parameters may be modified by the designer at terminal 102. Further details of the parameter modification process by the designer will be described below. The parameters may be typically modified and maintained by a business unit 114 responsible for the parameters database 108. For example, this business unit may be one or more engineering divisions of an automotive OEM. The business unit 114 may communicate with the database 108 from a terminal via a server 112. While servers 110 and 112 are illustrated separately for clarity and illustration, server 110 and 112 may alternatively be the same server. Further, databases 106 and 108 may be separate databases (as illustrated for clarity) or, in some embodiments, the data may be stored in a single database.

To create templates, a designer may query the database 106 to retrieve the template file(s) and load the template(s) using the CAD software 104 for viewing at the terminal 102. A template_setup file may be retrieved from the database 106 through a search query in order to begin the template creation process. Typically, although not necessarily, the most recent version of the setup file may be selected and/or received at the terminal 102. Further, the setup file may be loaded through manual steps performed by the user (e.g., and without limitation, selecting the setup file and instructing from menu option(s) to load the setup file to the software 104) or automatically once the setup file is selected.

The setup file may be associated with one or more assembly files which may include the template files for the vehicle seat(s). These assembly file(s) may include the CAD data corresponding to the design values for current seat design. In some embodiments, the assembly file(s) may include the latest (e.g., most recent) CAD data. There may be one or more template files associated with each assembly file. Each template file may be associated with a different component of the vehicle seat. One or more of the template files may be selected for updating and saved with a new identifier. A non-limiting example of a template file identifier may include the program code and the seat code. The file selection and save process may take place via the design software 104, directly at the template database 106, and/or directly at the parameters database 108 using, for example, a text-based and/or GUI search and save interface. The design templates may additionally or alternatively by an engineer (e.g., at engineering terminal 114).

Since the assembly file is provided a new identifier, the assembly files and/or individual template file(s) may be mapped to the templates database 106 and the parameters database 108. A user may instruct the association or mapping of the assembly file(s) through one or more manual inputs at the terminal 102. In some embodiment, the manual inputs may be one or more menu selections. Alternatively, the assembly file(s) may be mapped to the templates 106 and the parameters database 106 without any user intervention. For example, the template creation software may be programmed to automatically generate the association upon the user loading the setup file and/or naming the created template(s).

Once the template(s) have been created and saved, the template(s) may be displayed and accessed via the design software 104.

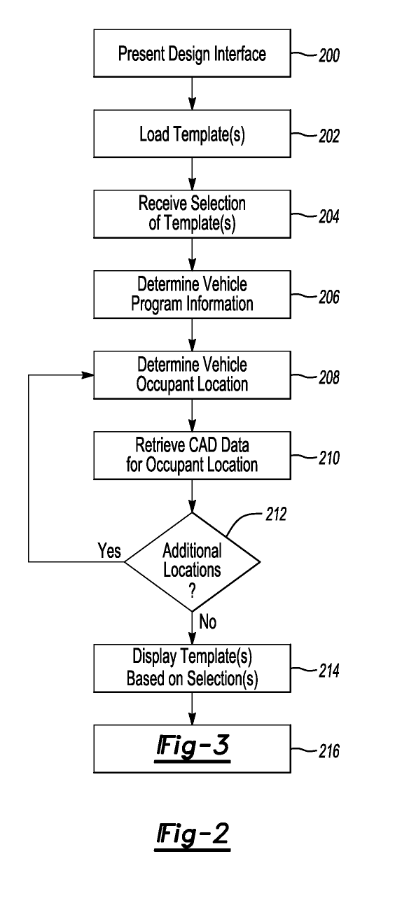

FIG. 2 illustrate a process for retrieving and displaying the design templates at the terminal 102 according to one embodiment. As illustrated in block 200, the initial design template may be displayed at the terminal 102 (e.g., when the design software is loaded). In some embodiments, the initial design template may be at body coordinates 0, 0, 0.

The templates created by the designer (as described above) may be loaded (block 202) in response to instructions from the user at the terminal 102. The instructions may be received through a series of commands on a graphical interface (such as, and without limitation, menu-based commands) and/or text-based commands. Once the templates are loaded, the template(s) may be selected for which the seat design values may be modified (block 204).

The vehicle program information (block 206) and the vehicle occupant location (block 208) for the seat design may be determined from user input. For example, the program information and occupant information may be selected from a menu of program information and occupant location. In alternative or additional embodiments, the user may select the design template(s) for modification and the program information and the occupant location determined from templates. As a non-limiting example, the information may be determined from the identifier associated with the template(s). The CAD data for the vehicle program and the occupant location may be retrieved from the database 106 (block 210).

In some embodiments, the designer may modify the seat design templates for multiple occupant locations. This may be determined based on the inputs provided by the user as described above. If the design is modifying multiple occupant locations (block 212), the occupant location(s) may be determined (block 204) and the CAD data for each location retrieved (block 210). The selected template(s) may be displayed at the terminal 102 (block 214).

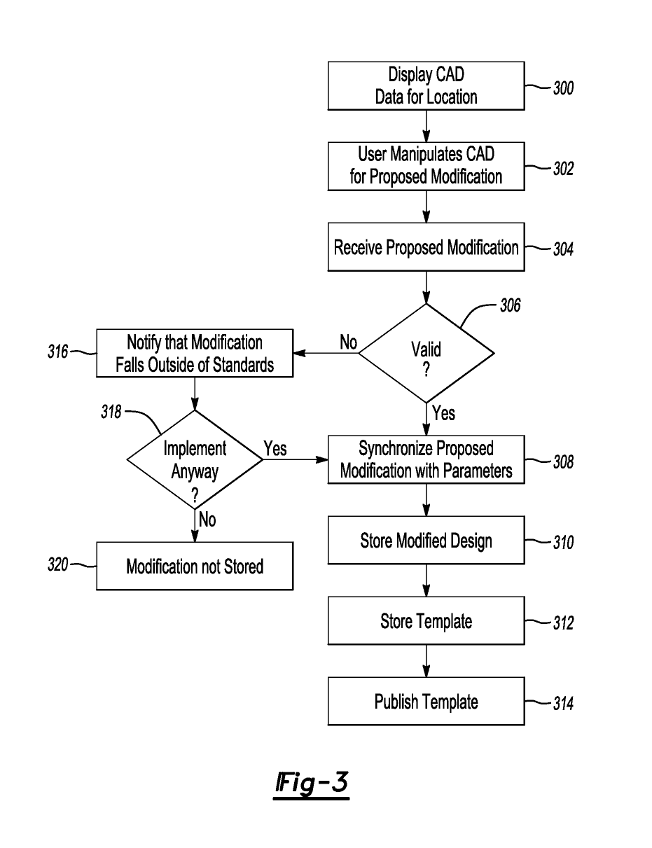

As continued in FIG. 3 and described below, the design values of the templates (corresponding to a seat component) may be modified from the terminal 102 via the design software 104. These modified design values may be validated in order to ensure compliance with standards and regulations for a product (e.g., a vehicle) and/or components of the product (e.g, a vehicle seat).

Ultimately, once validated, the modified design may serve as the utilized design for the product or product component during the life cycle of the product.

The design validation process of the various embodiments described is a wholistic process. The design values for each component of the seat are mapped (or linked) to each other so that a design modification to a single component is validated with respect to the other components. The validation pertains to the design's compliance with various standards defined for seats. These standards may be government imposed standards and/or OEM defined standards. A non-limiting example of government defined standards is the Federal Motor Vehicle Safety Standards (FMVSS) promulgated by the National Highway Traffic Safety Administration (NHTSA). A valid design modification for a seat component may be one which itself complies with either or both standards and, further, does not result in any other component to be out of compliance.

Accordingly, the templates database 106 may be associatively tied or mapped to design parameters 108 which may include the design values for the vehicle seats meeting the specific standards for the vehicle seats. In one embodiment, the design parameters 108 may be stored in an electronic spreadsheet (such as an EXCEL file). When a seat design is modified from the design software 104 (described in further detail below), the modifications may be assessed (e.g., validated) against the design parameters 108 to ensure compliance with the standards. By way of example and not limitation, a designer may desire to modify a seat component position from 725 mm to 750 mm. The decision to modify the positioning may be based on customer reviews, benchmarking data, or other intelligence about the vehicle seats. If the design parameters define the standard for the seat component at 720 mm to 740 mm, the modification does not comply with the standards and the designer may correspondingly receive a notification at the terminal 102 about the non-compliance. Since the seat design is tied to the design parameters 108, the template created by the user is also tied to the parameters 108. Certainly, the design parameters are not limited to position. Other parameters may include, but are not limited to, size of the seat component.

The design of the vehicle seat may be modified and saved in the newly identified templates using the design software 104. For example, the designer at terminal 102 may select the template(s) that were saved with the new identifier (as described above) and modify the design using the CAD data in the template.

FIG. 5 illustrates a selection of some of the design templates which are being modified (represented by the shaded templates). A select number of templates may be selected corresponding to the seat components that may be affected by a design modification. In some cases, all of the templates may be selected. For example, if the designer is modifying a design point of reference, all of the templates that are affected by that point of reference may be selected. Non-limiting examples are the Hip Point (“h-point”) point of reference or the Seat Ground Reference Point (“SgRP”). As is known in the art, the design of a vehicle seat may be performed using the “h-point” or SgRP, which may be generally defined as a point of origin for the location of the torso line of a manikin. Thus, if this point is modified, all of the templates for the seat may be correspondingly modified. Other non-limiting points of reference may include head angle, torso angle, thigh angle, and heel point.

In some embodiments, the templates may pertain to a zone of the vehicle seat and comprise one or more vehicle seat components within the vehicle seat zone. In such a case, a design modification may only affect the design values of other components within the zone. Likewise, the design modification may only be validated against the design values of the other components within the zone. Modification to a design value affecting all components, however, may be validated for compliance against design values for all components as described above.

Further details of the design modification process are described with respect to FIG. 3. The CAD data in the template for the vehicle occupant location may be displayed at the terminal 102 (block 300). Non-limiting examples of templates and the corresponding CAD data may include seats, head restraints, belts, lateral spacing, and child seats. From the template, the designer may manipulate the CAD data for modifying the design values (block 302). The designer may input modified design values and/or modify the graphical CAD data. Other forms of design manipulation maybe used without departing from the scope of the invention.

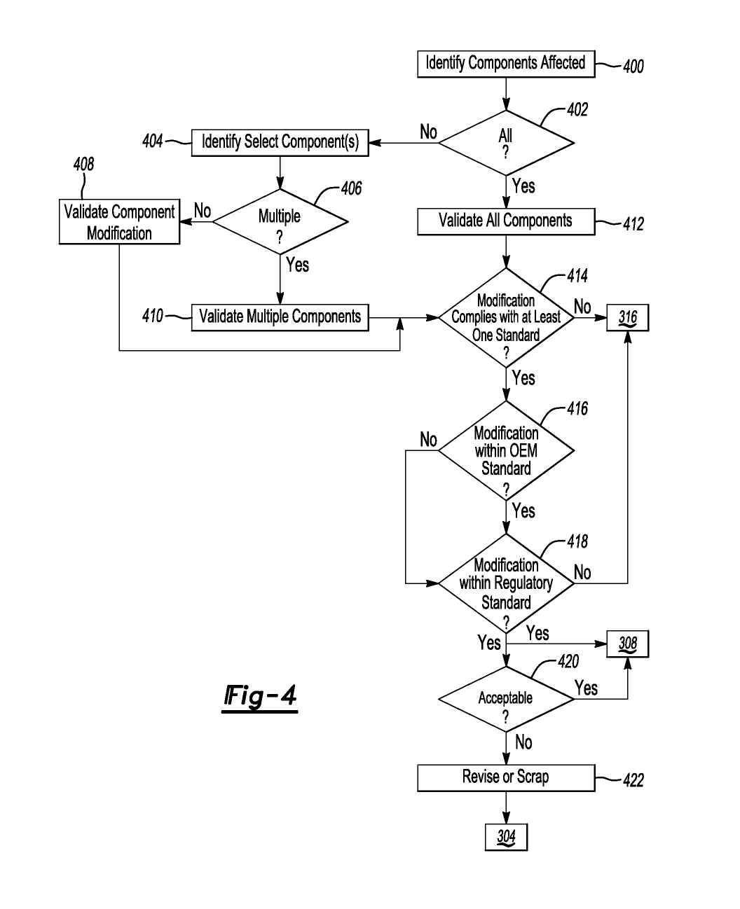

The design modification may be validated for compliance with defined regulatory and/or company standards for vehicle seats (block 306). The validation process may include assessing the proposed modified design against the design values stored in the parameters database 108. Further details of the validation process are described and illustrated with respect to FIG. 4.

Referring to FIG. 4, when the user modifies the seat design using the design software 104 (as described above), the seat components affected by the proposed design may be identified. The identification may be made by the user or automatically by the software 102. For example, and without limitation, the user may select the design template(s) for these components. Further details of this process are described above.

Alternatively, the software may automatically identify the affected seat components based on an associative relationship of the vehicle seat components in the CAD data database 106. For example, components may be associated based on operation of the components (e.g., components that worked together) or proximity of the components. In some embodiments, the components may be associatively related based on the vehicle seat zone (as described above). Accordingly, the software may automatically identify the component that is being modified and the components associated (e.g., functionally and/or spatially) with the component.

The design modification may affect all or some of the seat components (block 402). As a non-limiting example, if the modification is to the h-point of the vehicle seat, all of the components may consequently require an update. Accordingly, all of the components may be validated for compliance (block 412).

However, if the modification does not affect all of the seat components, the select components that are affected may be identified (block 404) manually (e.g., and without limitation, user selection of the templates corresponding to the components) or automatically (e.g., automatic selection by the software 104). Multiple components (e.g., less than all components) may still be affected by the modification (block 406). In this case, the multiple components may be validated for compliance with the standards (block 410). Multiple components may refer to the component being modified and at least one additional component. However, if a single component is affected, the single component may be validated for compliance (block 408). A single component may refer to the component being modified.

The modification to seat component(s) may be, and/or may cause one or more components to be, in or out of compliance with the defined standards. For example, a modification to the size, position, or other like design parameter of a seat component may or may not comply with the defined standards and/or cause an associated component (e.g., functionally, spatially, zonally, etc.) to be in or out of compliance. In some embodiments, there may be multiple standards with which the modification is to comply (e.g., regulatory standards and OEM-defined standards). Alternatively, the modification may comply with at least one standard to be in compliance. As used herein, “modification” may refer to the modified design parameter and/or the affected components.

As shown in the illustrative example in FIG. 4, a modification that may comply with at least one standard (block 414) may comply with OEM defined standards (block 416) and/or regulatory standards (block 418). The designer may be notified whether the modification complies with the standards and, therefore, is a valid modification. The notification may be presented as a text-based notification (e.g., in a pop up window or as an annotation), numerical notification, and/or as a graphical notification. In some embodiments, the graphical notification may be represented by CAD geometry. In some embodiments, the graphical notification may have a color coding schema. A non-limiting example of a graphical notification with a color-coded schema, a compliance indicator may be a traffic light which associates a green light with a compliant modification and a red light with a non-compliant modification. Of course, other implementations may be used without departing from the scope of the invention.

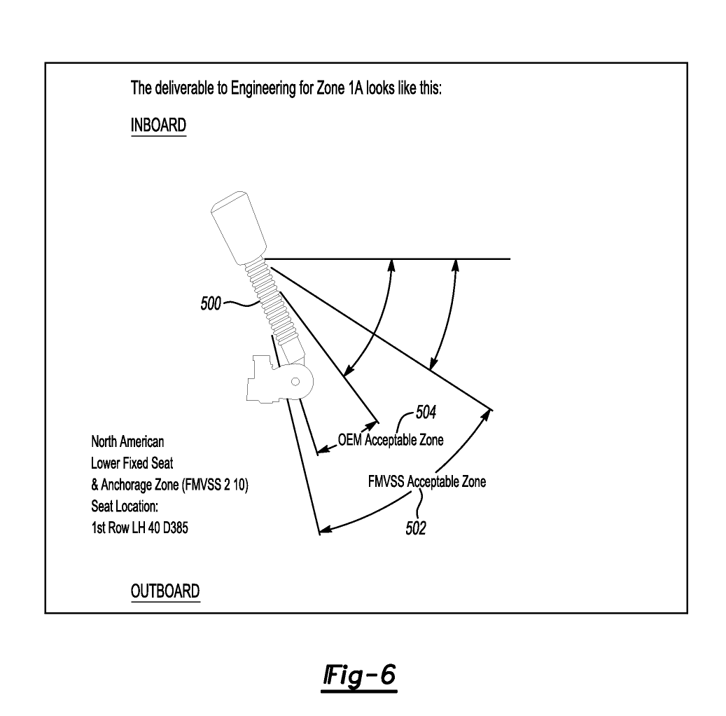

In some embodiments, compliance may falls within a compliance zone. The compliance zone may be displayed by the software 104 and, accordingly, the software 104 may determine whether the modification is compliant based on whether the modification falls within the one or more zones. FIG. 6 illustrates a non-limiting example of notifying a user of compliance using compliance zones. As illustrated in FIG. 6, the component that is modified 500 is within both the OEM-defined zone 502 and the regulatory zone 504.

Of course, if the modification does not comply with the standards, the modification is invalid according to the software 104. As illustrated with respect to block 316 in FIG. 3 (described in further detail below), the user may be notified that the modification does not comply. In some embodiments, notwithstanding the non-compliance, the modification may be stored in the template(s) and the modified design used in the design of the vehicle seat for the life cycle of the vehicle program or until another modification is made.

In some embodiments, a final approval by other business units within the OEM (e.g., and without limitation, engineering) for the modification may be required. The business unit may approve the proposed design before it is used in the design for the vehicle program. If not accepted, the modification may be scrapped or revised (block 422). If revised, the revisions to the modification may be implemented and the revised modification may be received (block 304 of FIG. 3). The validation process of the revised modification may be performed as described above.

Referring back to FIG. 3, the design modification may not be in compliance with the defined standards and, therefore, not valid. In this case, notification that the modification does not comply may be presented on the display (e.g., is invalid) (block 316). The non-compliant modification may not be stored in the parameters database 108 nor published as a design template 106 and, therefore, may not be used during seat design (block 320).

In some cases, notwithstanding the non-compliance, the modification may be implemented for the vehicle program (block 318). In some cases, approval may be required by another business unit (e.g., engineering) before the non-compliant modification may be implemented. Consequently, if approved, the modification becomes a compliant design.

Compliant modification inputs may be synchronized with the parameters database 108 (block 308). Instructions to synchronize the data may be received by the software 104 through one or more inputs at the terminal 102. As a non-limiting example, the designer may input textual and/or verbal commands and/or select a graphical button causing the synchronization to occur. Of course, other methods of instructions and inputs are also contemplated.

During or after data synchronization, the designer may ascertain if any associative relationship between the design data and the parameter data is broken. As described above, in order to validate design modifications, the design data for the templates 106 and the parameters data 108 may be associatively related. A text-based message (e.g., a pop up message) and/or a graphical message may be used to notify the designer of one or more broken associations. As one non-limiting example, an icon (e.g., green gears and blue chains) may be used in conjunction with the list or menu of templates. Different icons may represent whether or not the association is broken. Alternatively, the presence of an icon may represent an unbroken association while a missing icon represents a broken association. Of course, other methods of notifications are also contemplated. In the case that an association is broken, the association may be regenerated using the process described above.

Once the data is synchronized, the modified design may be stored in the template (block 310) and the template stored in the CAD template database 106 (block 312). The design may then be published for use in seat design for the vehicle program(s) (block 314).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer-implemented method for designing a vehicle assembly, the computer-implemented method comprising:
receiving modification size and/or position design data at a computer for a first vehicle component having a functional and/or spatial relationship with a second vehicle component having size and/or position design data;
automatically updating at the computer the size and/or position design data for the second vehicle component based on the modification size and/or position design data for the first vehicle component; and
determining a compliance status at the computer with one or more design standards defined for the vehicle component(s) for the first vehicle component or the second vehicle component based on the modification size and/or position design data and the updated size and/or position design data.

2. The computer-implemented method of claim 1 further comprising presenting the compliance status at the computer.

3. The computer-implemented method of claim 1 wherein the standards pertain to government standards, standards defined by an automotive OEM, or both.

4. The computer-implemented method of claim 1 further comprising:
displaying at the computer CAD data representing the first vehicle component, the second vehicle component, or both; and
receiving input modifying the CAD data representing the first vehicle component.

5. The computer-implemented method of claim 1 further comprising:
displaying at the computer size and/or position design data values associated with a size and/or position of the first vehicle component, the second vehicle component, or both; and
receiving input modifying the size and/or position design data values for the first vehicle component.

6. The computer-implemented method of claim 1 further comprising:
storing the size and/or position design data values for the first and second vehicle components on a database;
loading one or more design template representing a pre-modification design of the vehicle assembly;
associating the one or more design templates with the database; and
based on the associating, mapping the one or more design templates with the size and/or position data in the database.

7. The computer-implemented method of claim 6 wherein the mapping is performed automatically by software.

8. The computer-implemented method of claim 1 wherein the vehicle assembly is a vehicle seat.

9. A system for designing a vehicle assembly, the system comprising:
at least one data processor configured to:
display data representing a design of one or more vehicle components of a vehicle part assembly, the one or more vehicle components having an associated size and/or position design values;
receive a proposed modification to the one or more size and/or position design values of the one or more vehicle components, the one or more vehicle components being associated with other vehicle components of the vehicle part assembly having size and/or position design values;
update the size and/or position design values of the associated other vehicle components based on the proposed modification;
based on the respective size and/or position design values, determine a compliance status of the vehicle component(s) with one or more standards defined for the vehicle component(s); and
present the compliance status.

10. The system of claim 9 wherein the at least one data processor is further configured to present the compliance status as text-based notification.

11. The system of claim 9 wherein the compliance status is represented by a graphic.

12. The system of claim 11 wherein the compliance status is represented by at least one of a color scheme, CAD geometry, numerical values or annotations.

13. The system of claim 9 wherein the association between the vehicle components is one or more of a functional association, spatial association, and a zonal association.

14. The system of claim 13 further comprising a database of size and/or position design values configured to modify and update the size and/or position design values of the vehicle components having an association.

15. The system of claim 9 wherein the at least one data processor is further configured to save the modification to the vehicle part assembly if the vehicle component(s) comply with the standards.

16. The system of claim 9 where the at least data processor is further configured to receive input saving the modification to the vehicle part assembly notwithstanding non-compliance with the standards.

17. The system of claim 9 wherein the displayed data is CAD data.

18. A system comprising:
at least one computer configured to:
receive modification design data for a vehicle component associated with at least one other vehicle component having design data;
based on modification design data, correspondingly update the associated vehicle component design data; and
based on the modification and update, determine a compliance status for the vehicle component(s) with defined standards.

19. The system of claim 18 wherein the design data is size and/or position design data.

20. The system of claim 18 wherein the at least one computer is further configured to present the compliance status.
